(19) United States
(12) Patent Application Publication
(10) Pub. No.: US 2015/0035619 A1
(43) Pub. Date: Feb. 5, 2015

(54) PHASE SHIFTER AND METHOD OF SHIFTING PHASE OF SIGNAL

(71) Applicant: Electronics and Telecommunications Research Institute, Daejeon (KR)

(72) Inventors: Seong Mo MOON, Daejeon (KR); Dong Hwan SHIN, Daejeon (KR); In Bok YOM, Daejeon (KR); Han Lim LEE, Seoul (KR); Moon Que LEE, Seoul (KR)

(21) Appl. No.: 14/446,425

(22) Filed: Jul. 30, 2014

(30) Foreign Application Priority Data
Aug. 2, 2013 (KR) 10-2013-0092129
Jun. 10, 2014 (KR) 10-2014-0070009

(51) Int. Cl. H01P 1/18

(52) U.S. Cl. CPC H01P 1/18
USPC 333/156

(57) ABSTRACT

Provided is a phase shifter for shifting a phase of a signal the phase shifter including an input unit to split an input signal into a plurality of signals having different phases, a connection unit to change at least one of magnitudes and phases of the plurality of signals, apply the changed plurality of signals to a plurality of loads, and receive a plurality of return signals generated when the applied signals are returned by the plurality of loads, and an output unit to generate an output signal having a predetermined phase difference from the input signal based on the return signals.

### CROSS-REFERENCE TO RELATED APPLICATIONS

This application claims the benefit of Korean Patent Application No. 10-2013-0092129, filed on Aug. 2, 2013, and Korean Patent Application No. 10-2014-0070009, filed on Jun. 10, 2014, in the Korean Intellectual Property Office, the disclosures of which are incorporated herein by reference.

### BACKGROUND

1. Field of the Invention

Embodiments of the present invention relate to a phase shifter and a method of shifting a phase of a signal.

2. Description of the Related Art

A phase shifter is a component used most in application fields of microwave and millimeter-wave frequency bands, for example, a phase array transceiver, and a communication system. To optimize a system performance, the phase shifter may need to shift a phase to a desired phase with a less change in an insertion loss and an excellent characteristic with respect to a return loss. To resolve issues of the insertion loss and the return loss, modified rat-race structures using a reflection-type phase shifter, a vector-sum phase shifter, or a Lange coupler are widely used. In the aforementioned methods, signals generated by a mismatch in a reflective circuit may be returned to an input port.

There is a paper, titled “CMOS Passive Phase Shifter with Group-Delay Deviation of 6.3 ps at K-Band”, published on Pages 1178 through 1186 of IEEE TRANSACTIONS ON MICROWAVE THEORY AND TECHNIQUES, VOL. 59, NO. 7, July 2011. The paper discloses a phase shifter that may minimize a phase error and a change in an insertion loss using a phase-invertible variable attenuator.

### SUMMARY

According to an aspect of the present invention, there is provided a phase shifter including an input unit to split an input signal into a plurality of signals having different phases, a connection unit to change at least one of magnitudes and phases of the plurality of signals, apply the changed plurality of signals to a plurality of loads, and receive a plurality of return signals generated when the applied signals are returned by the plurality of loads, and an output unit to generate an output signal having a predetermined phase difference from the input signal based on the return signals.

According to another aspect of the present invention, there is provided a phase shifter including an input coupler to split an input signal into a plurality of divided input signals, an output coupler, a first coupler to connect one side of the input coupler to one side of the output coupler, and a second coupler to connect another side of the input coupler to another side of the output coupler. The first coupler and the second coupler may receive the plurality of divided input signals, apply a plurality of load application signals generated based on the plurality of divided input signals to a plurality of loads, and receive return signals generated when the applied load application signals are returned by the plurality of loads. The output coupler may output an output signal having a phase shifted by a predetermined value based on the return signals.

According to still another aspect of the present invention, there is provided a method of shifting a phase of a signal, the method including splitting an input signal into a plurality of divided input signals having different phases, generating a plurality of load application signals based on the plurality of divided input signals, applying the plurality of load application signals to a plurality of loads, and receiving return signals generated when the applied load application signals are returned by the plurality of loads, and outputting an output signal having a predetermined phase difference from the input signal based on a plurality of divided return signals generated based on the return signals.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a circuit diagram illustrating a phase shifter for shifting a phase of an input signal according to an embodiment of the present invention;

FIG. 2 is a circuit diagram illustrating a phase shifter for shifting a phase of an input signal using a plurality of couplers according to an embodiment of the present invention;

FIG. 3 is a flowchart illustrating a method of shifting a phase of an input signal, the method performed by a phase shifter according to an embodiment of the present invention;

FIG. 4 is a graph illustrating an insertion loss and a return loss of a phase shifter according to an embodiment of the present invention; and

FIG. 5 is a graph illustrating a phase value and an insertion loss variation when a phase shifter shifts a phase according to an embodiment of the present invention.

### DETAILED DESCRIPTION

Hereinafter, example embodiments will be described in detail with reference to the accompanying drawings.

Though the present invention may be variously modified and have several embodiments, specific embodiments will be shown in drawings and be explained in detail. However, the present invention is not meant to be limited, but it is intended that various modifications, equivalents, and alternatives are also covered within the scope of the claims.

Terms used herein are to merely explain certain embodiments, not meant to limit the scope of the present invention. A singular expression includes a plural concept unless there is a contextually distinctive difference therebetween. In this description, the term “include” or “have” is intended to indicate that characteristics, numbers, steps, operations, components, elements, etc. disclosed in the specification or combinations thereof exist. As such, the term “include” or “have” should be understood that there are additional possibilities of one or more other characteristics, numbers, steps, operations, components, elements or combinations thereof.

Unless specifically defined, all the terms used herein including technical or scientific terms have the same meaning as terms generally understood by those skilled in the art. Terms defined in a general dictionary should be understood so as to have the same meanings as contextual meanings of the related art. Unless definitely defined in the present invention, the terms are not interpreted as ideal or excessively formal meanings.

Hereinafter, certain embodiments of the present invention will be explained in more detail with reference to the attached drawings. The same component or components corresponding to each other will be provided with the same reference numeral, and their detailed explanation will be omitted. When it is determined that a detailed description is related to a related known function or configuration which may make the purpose of the present disclosure unnecessarily ambiguous in the description, such a detailed description will be omitted.

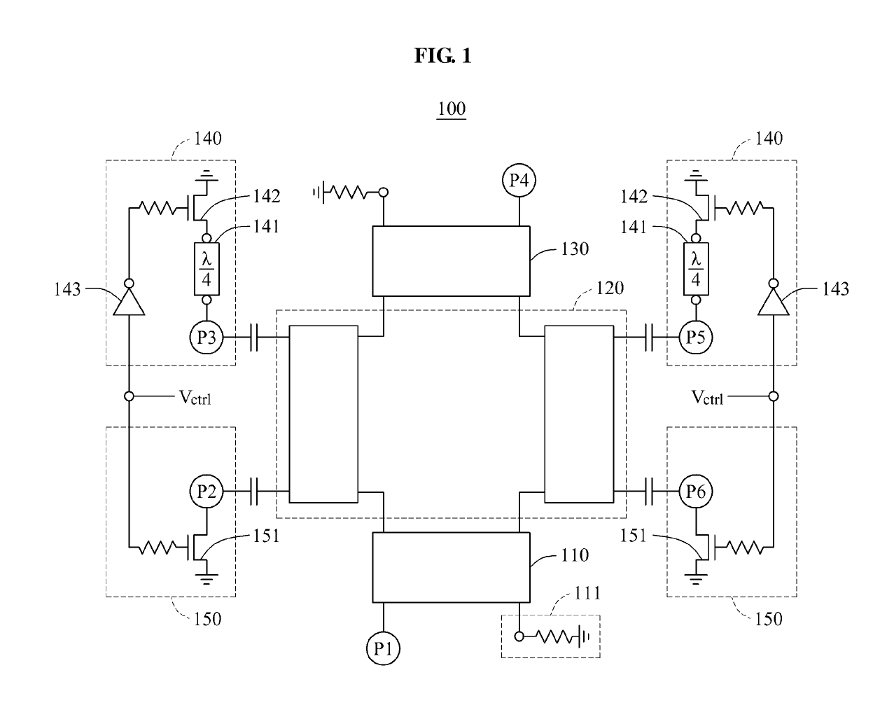

FIG. 1 is a circuit diagram illustrating a phase shifter 100 for shifting a phase of an input signal according to an embodiment of the present invention.

Referring to FIG. 1, the phase shifter 100 may include an input unit 110, a connection unit 120, and an output unit 130.

The input unit 110 may split an input signal into a plurality of signals having different phases. For example, the input unit 110 may split an input signal applied to P1 into a signal A and a signal B. In this example, the input unit 110 may split the input signal into signals having identical magnitudes and different phases. A phase difference between the signal A and the signal B may correspond to 180 degrees (°). The input unit 110 may be electrically connected to the connection unit 120. The plurality of signals may be applied to the connection unit 120.

The connection unit 120 may change at least one of the magnitudes and the phases of the plurality of signals. The connection unit 120 may split each of the plurality of signals and change at least one of the magnitudes and the phases of the plurality of signals. The connection unit 120 may split each of the plurality of signals into signals having identical magnitudes and different phases. For example, the connection unit 120 may split the signal A into a signal a1 and a signal a2, and the signal B into a signal b1 and a signal b2. In this example, the magnitude of the signal a1 may be identical to the magnitude of the signal a2, and a phase difference between the signal a1 and the signal a2 may correspond to 180°. In addition, the magnitude of the signal b1 may be identical to the magnitude of the signal b2, and a phase difference between the signal b1 and the signal b2 may correspond to 180°.

The connection unit 120 may be connected to a plurality of loads. The plurality of loads may include first loads 140 and second loads 150. The first loads 140 may be connected to the second loads 150, respectively. The first loads 140 respectively may include a quarter-wavelength transmission line 141, a transistor 142, and an inverter 143. The second loads 150 respectively may include a transistor 151. In this example, the transistors 142 and the transistors 151 may correspond to metal-oxide-semiconductor field-effect transistors (MOSFETs).

The first loads 140 may be electrically connected to the second loads 150, respectively. The first loads 140 and the second loads 150 may exhibit different operation characteristics in response to an application of a control signal. In response to an application of a control signal, the first loads 140 and the second loads 150 may exhibit different operation characteristics through the inverters 143, the transistors 142, and the transistors 151. For example, when a control signal sufficient to turn on the transistors 151 is applied, a control signal to be applied to the first loads 140 may have a magnitude insufficient to turn on the transistors 142 by the inverters 143. When a control signal insufficient to turn on the transistors 151 is applied, a control signal to be applied to the first loads 140 may have a magnitude sufficient to turn on the transistors 142 by the inverters 143.

Depending on a control signal to be applied, the transistors 142 of the first loads 140 may operate, and the transistors 151 of the second loads 150 may operate. Depending on a control signal to be applied, the transistors 142 of the first loads 140 may not operate, and the transistors 151 of the second loads 150 may operate. When a control signal satisfying a predetermined criterion is applied, the first loads 140 may exhibit operation characteristics differing from those of the second loads 150. When the control signal is sufficient to turn on the transistors 151, the control signal may satisfy the predetermined criterion. The predetermined criterion may be determined depending on a type of a transistor.

When a control signal satisfying the predetermined criterion is applied, the second loads 150 may be in a short state at P2 and P6, and the first loads 140 may be in an open state at P3 and P5. When a control signal not satisfying the predetermined criterion is applied, the second loads 150 may be in an open state at P2 and P6, and the first loads 140 may be in a short state at P3 and P5.

Hereinafter, a case in which a control signal satisfies the predetermined criterion will be referred to as a case in which a high control signal is applied. In addition, a case in which a controls signal does not satisfy the predetermined criterion will be referred to as a case in which a low control signal is applied. When a high control signal is applied, the second loads 150 may be in the short state, and the first loads 140 may be in the open state. When a low control signal is applied, the second loads 150 may be in the open state, and the first loads 140 may be in the short state.

The connection unit 120 may apply, to the first loads 140 and the second loads 150, a plurality of signals of which at least one of magnitudes and phases are changed. For example, the connection unit 120 may apply the signal a1 to the first load 140 connected to a left side of the connection unit 120, and apply the signal a2 to the second load 150 connected to the left side of the connection unit 120. In addition, the connection unit 120 may apply the signal b1 to the first load 140 connected to a right side of the connection unit 120, and apply the signal b2 to the second load 150 connected to the right side of the connection unit 120.

The signals applied to the plurality of loads 140 and 150 may be returned. The signal a1 may be returned by the first load 140 connected to the left side of the connection unit 120. The signal a2 may be returned by the second load 150 connected to the left side of the connection unit 120. The signal b1 may be returned by the first load 140 connected to the right side of the connection unit 120. The signal b2 may be returned by the second load 150 connected to the right side of the connection unit 120.

The connection unit 120 may receive a plurality of signals returned by a plurality of loads. The connection unit 120 may receive a plurality of signals returned by the plurality of loads 140 and 150 connected to the left side of the connection unit 120, and generate a return signal (a signal Ra) based on the received plurality of signals. In addition, the connection unit 120 may receive a plurality of signals returned by the plurality of loads 140 and 150 connected to the right side of the connection unit 120, and generate a return signal (a signal Rb) based on the received plurality of signals.

The connection unit 120 may split the received return signals into a plurality of signals. The connection unit 120 may split each of the signal Ra and the signal Rb. For example, the connection unit 120 may split the signal Ra into a signal ra1 and a signal ra2. The connection unit 120 may split the signal Rb into a signal rb1 and a signal rb2. The connection unit 120 may split the return signals into return signals to be applied to the input unit 110 and return signals to be applied to the output unit 130.

The split return signals may be applied to the input unit 110 and the output unit 130, respectively. For example, the signal ra1 and the signal rb1 may be applied to the input unit 110, and the signal ra2 and the signal rb2 may be applied to the output unit 130. The split return signals applied to the output unit 130 may correspond to desired signals, and the split return signals applied to the input unit 110 may correspond to undesired signals.

The output unit 130 may generate an output signal having a predetermined phase difference from the input signal based on the return signals applied to the output unit 130. For example, the output unit 130 may generate an output signal based on the signal ra2 and the signal rb2 generated by splitting the return signals. In detail, the output unit 130 may generate a plurality of divided output signals by splitting each of the signal ra2 and the signal rb2. The output unit 130 may couple one of a plurality of divided output signals generated by splitting the signal ra2 with one of a plurality of divided output signals generated by splitting the signal rb2. The output unit 130 may generate the output signal by coupling a portion of the generated plurality of divided output signals.

The signal ra1 and the signal rb1 applied to the input unit 110 may correspond to undesired signals, which may deteriorate a performance of the phase shifter 100. When an undesired signal is generated, a direct current (DC) offset may occur. The input unit 110 may generate a plurality of divided return signals by splitting each of the signal ra1 and the signal rb1. The input unit 110 may couple one of a plurality of divided return signals generated by splitting the signal ra1 with one of a plurality of divided return signals generated by splitting the signal rb1. The input unit 110 may couple a portion of the plurality of divided return signals. The input unit 110 may output the coupled signal to an isolation port 111. When the input unit 110 outputs the undesired signals to the isolation port 111, a deterioration in the performance of the phase shifter 100 caused by a DC offset may be prevented. The input unit 110 may output a leakage signal generated based on the signal ra1 and the signal rb1 to the isolation port 111.

The connection unit 120 may include at least two couplers. Each coupler included in the connection unit 120 may be connected to the plurality of loads 140 and 150.

The input unit 110, the connection unit 120, and the output unit 130 may include couplers. The couplers included in the input unit 110, the connection unit 120, and the output unit 130 may correspond to identical types of couplers. For example, the couplers included in the input unit 110, the connection unit 120, and the output unit 130 may correspond to Lange couplers.

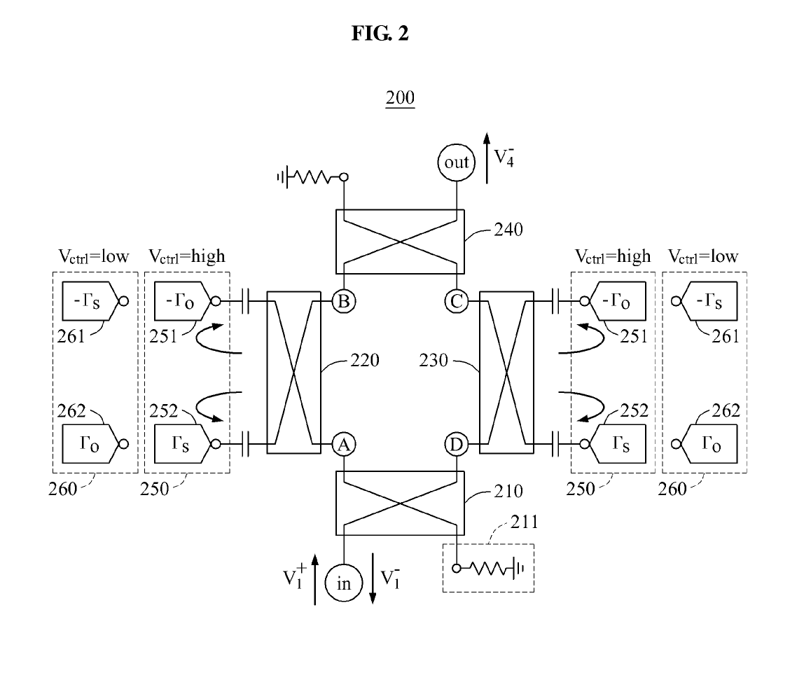

FIG. 2 is a circuit diagram illustrating a phase shifter 200 for shifting a phase of an input signal using a plurality of couplers according to an embodiment of the present invention.

In advance of descriptions on the phase shifter 200, a process of splitting a signal using a coupler will be described briefly. The coupler may include four ports. The coupler may include an input port, two output ports, and an isolation port. A signal input through the input port may be split, and split signals may be output through the two output ports. Through an output port facing the input port, a signal having 3 decibels (dB) reduced power, when compared to the input signal, may be output. Through an output port disposed in a diagonal direction from the input port, a signal having 3 dB reduced power and a different phase, when compared to the input signal, may be output. When A denotes the input signal, a signal

$$\frac{1}{\sqrt{2} *} A$$

may be output through the output port facing the input port, and a signal

$$\frac{- j}{\sqrt{2} *} A$$

may be output through the output port disposed in the diagonal direction from the input port.

Referring to FIG. 2, the phase shifter 200 may include an input coupler 210, a first coupler 220, a second coupler 230, and an output coupler 240.

The first coupler 220 may connect one side of the input coupler 210 to one side of the output coupler 230. The second coupler 230 may connect another side of the input coupler 220 and another side of the output coupler 230.

The input coupler 210 may receive an input signal V₁⁺. The input coupler 210 may split the input signal V₁⁺. The input coupler 210 may split the input signal V₁⁺ into a signal V_{A} and a signal V_{D}. The signal V_{A} and the signal V_{D} may be expressed using Equations 1 and 2, respectively.

$$\begin{matrix}{V}_{A} = \frac{1}{\sqrt{2}} {V}_{1}^{+} & [ Equation 1 ] \\ {V}_{D} = \frac{- j}{\sqrt{2}} {V}_{1}^{+} & [ Equation 2 ]\end{matrix}$$

A signal output through a node A may correspond to the signal output through the port facing the input port, and a signal output through a node D may correspond to the signal output through the port disposed in the diagonal direction from the input port. The signal V_{A} is a signal corresponding to the input signal multiplied by

$$\frac{1}{\sqrt{2}} ,$$

and the signal V_{D} is a signal corresponding to the input signal multiplied by

$$\frac{- j}{\sqrt{2}} .$$

The signal V_{A} may be applied to the first coupler 220, and the signal V_{D} may be applied to the second coupler 230. The first coupler 220 may split the signal V_{A}. Signals split from the signal V_{A} may be expressed by

$$\frac{1}{\sqrt{2}} {V}_{1}^{+} ( \frac{1}{\sqrt{2}} + \frac{- j}{\sqrt{2}} ) .$$

The signals

$$\frac{1}{\sqrt{2}} {V}_{1}^{+} ( \frac{1}{\sqrt{2}} + \frac{- j}{\sqrt{2}} )$$

may be applied to a plurality of loads 251 and 252 or a plurality of loads 261 and 262 connected to the first coupler 220. An imaginary part of

$$\frac{1}{\sqrt{2}} {V}_{1}^{+} ( \frac{1}{\sqrt{2}} + \frac{- j}{\sqrt{2}} )$$

may correspond to a signal to be applied to a first load 251 or 261, and a real part of

$$\frac{1}{\sqrt{2}} {V}_{1}^{+} ( \frac{1}{\sqrt{2}} + \frac{- j}{\sqrt{2}} )$$

may correspond to a signal to be applied to a second load 252 or 262. The first coupler 220 may generate a plurality of load application signals to be applied to the plurality of loads 251 and 252 or the plurality of loads 261 and 262 based on the signal V_{A}.

The first load 251 or 261 disposed on a left side of the first coupler 220 may include a quarter-wavelength transmission line. A first load 251 or 261 disposed on a right side of the second coupler 230 may also include a quarter-wavelength transmission line.

As described with reference to FIG. 1, in a case 250 in which a high control signal is applied, the first load 251 may be in an open state, and the second load 252 may be in a short state. Hereinafter, it may be assumed that a high control signal is applied to the plurality of loads 251 and 252.

When the signals split from the signal V_{A} are applied to the plurality of loads 251 and 252 connected to the first coupler 220, the signals split from the signal V_{A} may be returned by the plurality of loads 251 and 252 connected to the first coupler 220. The first coupler 220 may receive return signals generated when the signals split from the signal V_{A} are returned by the plurality of loads 251 and 252.

The return signals received by the first coupler 220 may be expressed by

$$\frac{1}{\sqrt{2}} {V}_{1}^{+} ( \frac{1}{\sqrt{2}} Γ s - \frac{- j}{\sqrt{2}} Γ o ) .$$

In this example, −Γ_{O} denotes a reflection coefficient of a first load, and Γ_{S} denotes a reflection coefficient of a second load. An imaginary part of

$$\frac{1}{\sqrt{2}} {V}_{1}^{+} ( \frac{1}{\sqrt{2}} Γ s - \frac{- j}{\sqrt{2}} Γ o )$$

may correspond to a signal returned by the first load 251, and a real part of

$$\frac{1}{\sqrt{2}} {V}_{1}^{+} ( \frac{1}{\sqrt{2}} Γ s - \frac{- j}{\sqrt{2}} Γ o )$$

may correspond to a signal returned by the second load 252.

The first coupler 220 may split the return signals

$$\frac{1}{\sqrt{2}} {V}_{1}^{+} ( \frac{1}{\sqrt{2}} Γ s - \frac{- j}{\sqrt{2}} Γ o )$$

into a plurality of divided return signals. The first coupler 220 may split the return signals

$$\frac{1}{\sqrt{2}} {V}_{1}^{+} ( \frac{1}{\sqrt{2}} Γ s - \frac{- j}{\sqrt{2}} Γ o )$$

into a divided return signal to be applied to the input coupler 210, and a divided return signal to be applied to the output coupler 240. When V_{A}⁺ denotes the divided return signal to be applied to the input coupler 210, and V_{B}⁺ denotes the divided return signal to be applied to the output coupler 240, the divided return signal V_{A}⁺ and the divided return signal V_{B}⁺ may be expressed by Equations 3 and 4, respectively.

$$\begin{matrix}{V}_{A}^{+} = \frac{1}{\sqrt{2}} {V}_{1}^{+} ( \frac{1}{\sqrt{2}} \frac{1}{\sqrt{2}} Γ s - \frac{- j}{\sqrt{2}} \frac{- j}{\sqrt{2}} Γ o ) = \frac{1}{\sqrt{2}} {V}_{1}^{+} ( \frac{1}{2} Γ s + \frac{1}{2} Γ o ) = \frac{1}{2 \sqrt{2}} \cdot ( {Γ}_{S} + {Γ}_{O} ) \cdot {V}_{1}^{+} & [ Equation 3 ] \\ {V}_{B}^{+} = \frac{J}{2 \sqrt{2}} \cdot ( - {Γ}_{S} + {Γ}_{O} ) \cdot {V}_{1}^{+} & [ Equation 4 ]\end{matrix}$$

The divided return signal V_{B}⁺ may be induced by multiplying the real part of

$$\frac{1}{\sqrt{2}} {V}_{1}^{+} ( \frac{1}{\sqrt{2}} Γ s - \frac{- j}{\sqrt{2}} Γ o ) by \frac{- j}{\sqrt{2}} ,$$

and multiplying the imaginary part of

$$\frac{1}{\sqrt{2}} {V}_{1}^{+} ( \frac{1}{\sqrt{2}} Γ s - \frac{- j}{\sqrt{2}} Γ o ) by \frac{1}{\sqrt{2}} .$$

The second coupler 230 may split the signal V_{D}. Signals split from the signal V_{D} may be applied to the plurality of loads 251 and 252 connected to the second coupler 230. The second coupler 230 may apply a signal

$$\frac{- j}{\sqrt{2} *} {V}_{D}$$

to the first load 251, and apply a signal

$$\frac{1}{\sqrt{2} *} {V}_{D}$$

to the second load 252. The second coupler 230 may generate a plurality of load application signals to be applied to the plurality of loads 251 and 251 based on the signal V_{D}.

When a high control signal is applied as described above, the first load 251 may be in an open state, and the second load 252 may be in a short state. When the signals split from the signal V_{D} are applied to the plurality of loads 251 and 252 connected to the second coupler 230, the signals split from the signal V_{D} may be returned by the plurality of loads 251 and 252. The second coupler 230 may receive return signals generated when the signals split from the signal V_{D} are returned by the plurality of loads 251 and 252.

The second coupler 230 may split the return signals into a plurality of divided return signals. The second coupler 230 may split the return signals into a divided return signal to be applied to the input coupler 210 and a divided return signal to be applied to the output coupler 240. When V_{D}⁺ denotes the divided return signal to be applied to the input coupler 210, and V_{C}⁺ denotes the divided return signal to be applied to the output coupler 240, the divided return signal V_{C}⁺ and the divided return signal V_{D}⁺ may be expressed by Equations 5 and 6, respectively.

$$\begin{matrix}{V}_{C}^{+} = \frac{- 1}{2 \sqrt{2}} \cdot ( {Γ}_{S} - {Γ}_{O} ) \cdot {V}_{1}^{+} & [ Equation 5 ] \\ {V}_{D}^{+} = \frac{- j}{2 \sqrt{2}} \cdot ( {Γ}_{S} + {Γ}_{O} ) \cdot {V}_{1}^{+} & [ Equation 6 ]\end{matrix}$$

The divided return signal V_{B}⁺ and the divided return signal V_{C}⁺ may be applied to the output coupler 240. A port connected to a node B may be disposed in a diagonal direction from an output port of the output coupler 240. The divided return signal V_{B}⁺ input through the port connected to the node B may be split into a signal

$$\frac{1}{\sqrt{2} *} {V}_{B}^{+}$$

and a signal

$$\frac{- j}{\sqrt{2} *} {V}_{B}^{+}$$

by the output coupler 240. A port connected to a node C may be disposed to face the output port of the output coupler 240. The divided return signal V_{C}⁺ input through the port connected to the node C may be split into a signal

$$\frac{1}{\sqrt{2} *} {V}_{C}^{+}$$

and a signal

$$\frac{- j}{\sqrt{2} *} {V}_{C}^{+}$$

by the output coupler 240. An output signal to be output through the output port of the output coupler 240 may correspond to a signal in which the signal

$$\frac{- j}{\sqrt{2} *} {V}_{B}^{+}$$

and the signal

$$\frac{- j}{\sqrt{2} *} {V}_{C}^{+}$$

are coupled by the output coupler 240. When V₄⁻ denotes the output signal to be output through the output port, the output signal V₄⁻ may be expressed by Equation 7.

$$\begin{matrix}{V}_{4}^{-} = \frac{- j}{\sqrt{2}} {V}_{B}^{+} + \frac{1}{\sqrt{2}} {V}_{C}^{+} = \frac{- j}{\sqrt{2}} \frac{j}{2 \sqrt{2}} \cdot ( - {Γ}_{S} + {Γ}_{O} ) \cdot {V}_{1}^{+} + \frac{1}{\sqrt{2}} \frac{- 1}{2 \sqrt{2}} \cdot ( {Γ}_{S} - {Γ}_{O} ) \cdot {V}_{1}^{+} \\ = \frac{1}{4} \cdot ( - {Γ}_{S} + {Γ}_{O} ) \cdot {V}_{1}^{+} + \frac{- 1}{4} \cdot ( {Γ}_{S} - {Γ}_{O} ) \cdot {V}_{1}^{+} \\ = - \frac{1}{4} \cdot ( {Γ}_{S} + {Γ}_{O} ) \cdot {V}_{1}^{+} + \frac{- 1}{4} \cdot ( {Γ}_{S} - {Γ}_{O} ) \cdot {V}_{1}^{+} = - \frac{1}{2} \cdot ( {Γ}_{S} - {Γ}_{O} ) {V}_{1}^{+}\end{matrix} \qquad [ Equation 7 ]$$

When the input signal V₁⁺ passes through the phase shifter 220 and is output as the output signal V₁⁻, a magnitude of the input signal V₁⁺ may be amplified. When Vₒᵤₜ denotes power to be amplified, the power Vₒᵤₜ may be expressed by Equation 8.

$$\begin{matrix}{V}_{out} {\vert}_{{v}_{out} = high} = \frac{{V}_{4}^{-}}{{V}_{1}^{+}} = \frac{- j}{\sqrt{2}} \cdot \frac{{V}_{B}}{{V}_{1}^{+}} + \frac{1}{\sqrt{2}} \cdot \frac{{V}_{C}}{{V}_{1}^{+}} = - \frac{1}{2} \cdot ( {Γ}_{S} - {Γ}_{O} ) \\ = {S}_{1}\end{matrix} \qquad [ Equation 8 ]$$

Conversely, in a case 260 in which a low control signal is applied, the first load 261 may be in a short state, and the second load 262 may be in an open state. In the case 260, a reflection coefficient of the first load 261 may correspond to −Γ_{S}, and a reflection coefficient of the second load 262 may correspond to Γ_{O}.

The first coupler 220 and the second coupler 230 may receive the signals returned by the plurality of loads 261 and 262. The first coupler 220 and the second coupler 230 may split the return signals into the plurality of divided return signals. The plurality of divided return signals may be expressed by Equations 9 through 12.

$$\begin{matrix}{V}_{A}^{+} = \frac{1}{2 \sqrt{2}} \cdot ( {Γ}_{S} + {Γ}_{O} ) \cdot {V}_{1}^{+} & [ Equation 9 ] \\ {V}_{B}^{+} = \frac{- j}{2 \sqrt{2}} \cdot ( - {Γ}_{S} + {Γ}_{O} ) \cdot {V}_{1}^{+} & [ Equation 10 ] \\ {V}_{C}^{+} = \frac{1}{2 \sqrt{2}} \cdot ( {Γ}_{S} - {Γ}_{O} ) \cdot {V}_{1}^{+} & [ Equation 11 ] \\ {V}_{D}^{+} = \frac{- j}{2 \sqrt{2}} \cdot ( {Γ}_{S} + {Γ}_{O} ) \cdot {V}_{1}^{+} & [ Equation 12 ]\end{matrix}$$

The first coupler 220 may generate the divided return signal V_{A}⁺ and the divided return signal V_{B}⁺. The second coupler 230 may generate the divided return signal V_{C}⁺ and the divided return signal V_{D}⁺.

V_{A}⁺ denotes the divided return signal at the node A, V_{B}⁺ denotes the divided return signal at the node B, V_{C}⁺ denotes the divided return signal at the node C, and V_{B}⁺ denotes the divided return signal at the node D.

Similar to the case 250 in which a high control signal is applied, the output coupler 240 may generate the output signal V₄⁻. The output signal V₄⁻ may be expressed by Equation 13.

$$\begin{matrix}{V}_{4}^{-} = \frac{- j}{\sqrt{2}} {V}_{B}^{+} + \frac{1}{\sqrt{2}} {V}_{C}^{+} = \frac{- j}{\sqrt{2}} \frac{- j}{2 \sqrt{2}} \cdot ( - {Γ}_{S} + {Γ}_{O} ) \cdot {V}_{1}^{+} + \frac{1}{\sqrt{2}} \frac{1}{2 \sqrt{2}} \cdot ( {Γ}_{S} - {Γ}_{O} ) \cdot {V}_{1}^{+} \\ = \frac{- 1}{4} \cdot ( - {Γ}_{S} + {Γ}_{O} ) \cdot {V}_{1}^{+} + \frac{1}{4} \cdot ( {Γ}_{S} - {Γ}_{O} ) \cdot {V}_{1}^{+} \\ = \frac{1}{4} \cdot ( {Γ}_{S} - {Γ}_{O} ) \cdot {V}_{1}^{+} + \frac{1}{4} \cdot ( {Γ}_{S} - {Γ}_{O} ) \cdot {V}_{1}^{+} = \frac{1}{2} \cdot ( {Γ}_{S} - {Γ}_{O} ) {V}_{1}^{+}\end{matrix} \qquad [ Equation 13 ]$$

In the case 260 in which a low control signal is applied, when the input signal V₁⁺ passes through the phase shifter 200 and is output as the output signal V₄⁻, a magnitude of the input signal V₁⁺ may be amplified. When Vₒᵤₜ denotes power to be amplified, the power Vₒᵤₜ may be expressed by Equation 14.

$${V}_{out} {\vert}_{{v}_{out} = low} = \frac{{V}_{4}^{-}}{{V}_{1}^{+}} = \frac{- j}{\sqrt{2}} \cdot \frac{{V}_{B}}{{V}_{1}^{+}} + \frac{1}{\sqrt{2}} \cdot \frac{{V}_{C}}{{V}_{1}^{+}} = - \frac{1}{2} \cdot ( {Γ}_{O} - {Γ}_{S} ) = {S}_{2} = - {S}_{1} \qquad [ Equation 14 ]$$

Referring to Equations 8 and 14, a signal S₁ and a signal S₂ may have identical magnitudes and different phases. A phase difference between the signal S₁ and the signal S₂ may correspond to 180°. When a mismatch occurs between the reflection coefficient Γ_{O} and the reflection coefficient Γ_{S} (that is, when Γ_{O}≠−Γ_{S}), an insertion loss may occur. However, although a mismatch occurs between the reflection coefficient Γ_{O} and the reflection coefficient Γ_{S}, the phase shifter 200 may generate an output signal based on Equations 8 and 14.

The output coupler 240 may generate an output signal. The output signal may correspond to a signal generated by shifting the phase of the input signal. Based on whether the control signal satisfies the predetermined criterion, the output coupler 240 may generate an output signal having a phase identical to the phase of the input signal, or an output signal having a phase difference of 180° or about 180° from the input signal.

The input coupler 210 may receive the divided return signals V_{A}⁺ and the divided return signal V_{D}⁺. The input coupler 210 may split the divided return signal V_{A}⁺ into a signal

$$\frac{1}{\sqrt{2} *} {V}_{A}^{+}$$

and a signal

$$\frac{- j}{\sqrt{2} *} {V}_{A}^{+} .$$

In addition, the input coupler 210 may split the divided return signal V_{D}⁺ into a signal

$$\frac{1}{\sqrt{2} *} {V}_{D}^{+}$$

and a signal

$$\frac{- j}{\sqrt{2} *} {V}_{D}^{+} .$$

The input coupler 210 may couple one of the signals split from the divided return signal V_{A}⁺ with one of the signals split from the divided return signal V_{D}⁺. When V₁⁻ denotes a signal to be returned to the input port of the input coupler 210, the signal V₁⁻ may be expressed by Equation 15.

$$\begin{matrix}{V}_{1}^{-} = \frac{1}{\sqrt{2}} {V}_{A}^{+} + \frac{- j}{\sqrt{2}} {V}_{D}^{+} = \frac{1}{\sqrt{2}} \frac{1}{2 \sqrt{2}} \cdot ( {Γ}_{S} + {Γ}_{O} ) \cdot {V}_{1}^{+} + \frac{- j}{\sqrt{2}} \frac{- j}{2 \sqrt{2}} \cdot ( {Γ}_{S} + {Γ}_{O} ) \cdot {V}_{1}^{+} \\ = \frac{1}{4} \cdot ( {Γ}_{S} + {Γ}_{O} ) \cdot {V}_{1}^{+} + \frac{- 1}{4} \cdot ( {Γ}_{S} - {Γ}_{O} ) \cdot {V}_{1}^{+} \\ = \frac{1}{4} \cdot {V}_{1}^{+} \cdot [ ( {Γ}_{S} + {Γ}_{O} ) - ( {Γ}_{S} + {Γ}_{O} ) ]\end{matrix} \qquad [ Equation 15 ]$$

In Equation 15, the signal V₁⁻ returned to the input port of the input coupler 210 may correspond to “0”.

When a mismatch occurs between the reflection coefficient Γ_{O} and the reflection coefficient Γ_{S}, the signal V₁⁻ may not correspond to “0”. When a mismatch occurs between the reflection coefficient Γ_{O} and the reflection coefficient Γ_{S}, a leakage signal to be returned to the input coupler 210 may be generated based on the divided return signal V_{A}⁺ and the divided return signal V_{D}⁺. The leakage signal may cause a DC offset in the phase shifter 200. Thus, the input coupler 210 may output the leakage signal generated based on the divided return signal V_{A}⁺ and the divided return signal V_{D}⁺ to an isolation port 211. When a mismatch occurs between the reflection coefficient Γ_{O} and the reflection coefficient Γ_{S}, the input coupler 210 may output, to the isolation port 211, the leakage signal generated based on the divided return signals applied to the input coupler 210. By outputting the leakage signal to the isolation port 211, a DC offset that may occur in the phase shifter 200 may be eliminated. When the DC offset is eliminated, a deterioration in a performance of the phase shifter 200 may be overcome.

The input coupler 210, the first coupler 220, the second coupler 230, and the output coupler 240 may correspond to identical types of couplers. For example, the input coupler 210, the first coupler 220, the second coupler 230, and the output coupler 240 may correspond to Lange couplers.

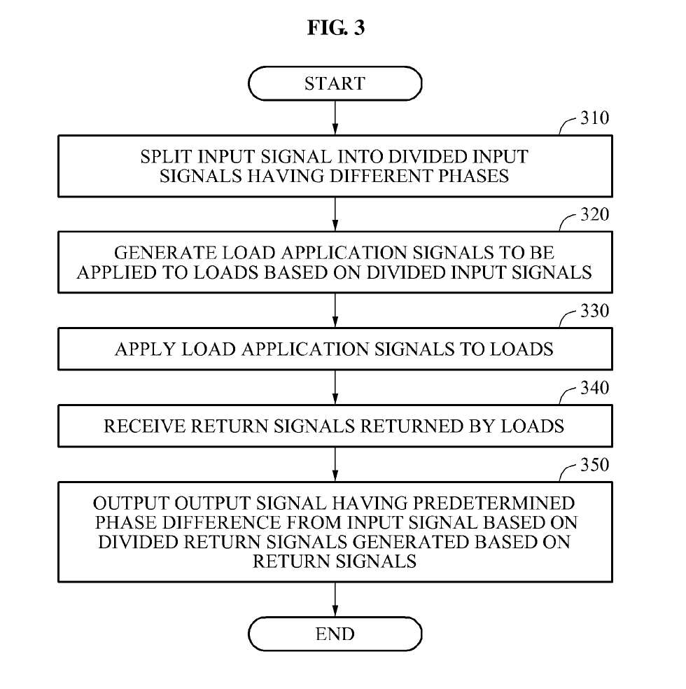

FIG. 3 is a flowchart illustrating a method of shifting a phase of an input signal, the method performed by a phase shifter according to an embodiment of the present invention.

Referring to FIG. 3, in operation 310, the phase shifter may split an input signal into a plurality of divided input signals having different phases. The phase shifter may include an input coupler. The phase shifter may split the input signal into the plurality of divided input signals through the input coupler. The divided input signals may have identical magnitudes and a phase difference of 180°.

In operation 320, the phase shifter may generate a plurality of load application signals based on the plurality of divided input signals. The phase shifter may further include a plurality of couplers. The phase shifter may split each of the plurality of divided input signals into a plurality of load application signals by applying the plurality of divided input signals to the plurality of couplers, respectively.

In operation 330, the phase shifter may apply the plurality of load application signals to a plurality of loads. The load application signals applied to the plurality of loads may be returned by the plurality of loads. In operation 340, the phase shifter may receive return signals returned by the plurality of loads.

The phase shifter may generate a plurality of divided return signals based on the return signals. In this example, the phase shifter may split the return signals into the plurality of divided return signals by applying the return signals to the plurality of couplers. In operation 350, the phase shifter may generate an output signal having a predetermined phase difference from the input signal based on the plurality of divided return signals.

In operation 350, the phase shifter may generate the output signal by coupling a portion of the plurality of divided return signals. The phase shifter may split divided return signals applied to the output coupler into a plurality of divided output signals. The phase shifter may generate the output signal by coupling a portion of the plurality of divided output signals.

The descriptions provided with reference to FIGS. 1 and 2 may be applied to the method of FIG. 3 and thus, duplicated descriptions will be omitted for conciseness.

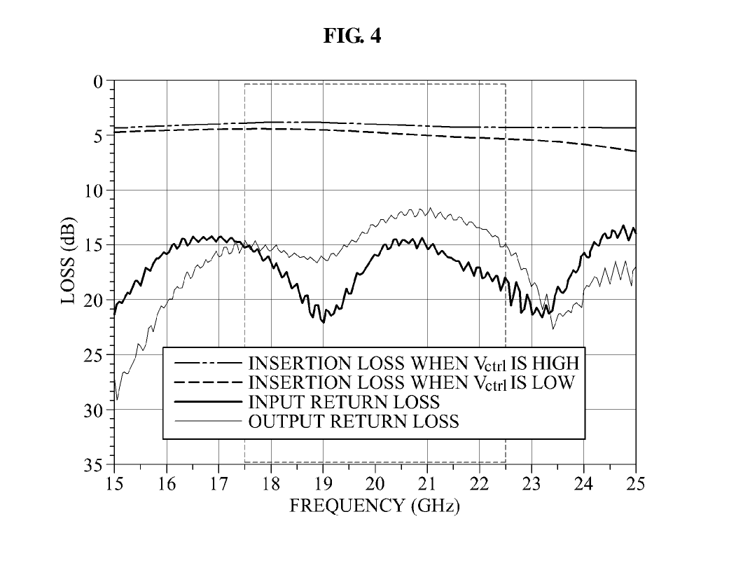

FIG. 4 is a graph illustrating an insertion loss and a return loss of a phase shifter according to an embodiment of the present invention.

Referring to FIG. 4, when a high control signal or a low control signal is applied, the insertion loss of the phase shifter corresponds to about 4.5±0.8 dB. In a frequency band ranging from 17.5 gigahertz (GHz) to 22.5 GHz, an input return loss corresponds to about 15 dB, and an output return loss corresponds to about 12 dB.

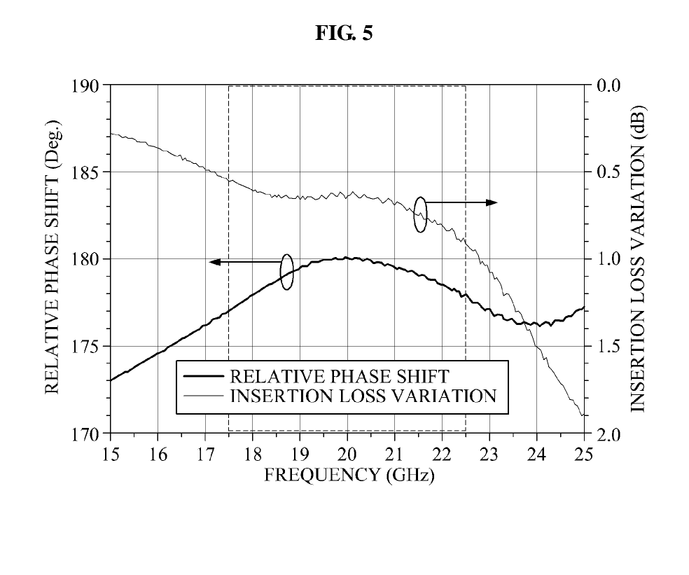

FIG. 5 is a graph illustrating a phase value and an insertion loss variation when a phase shifter shifts a phase according to an embodiment of the present invention.

Referring to FIG. 5, in a frequency band ranging from 17.5 GHz to 22.5 GHz, a relative phase shift corresponds to about 179±1.5°. In the frequency band ranging from 17.5 GHz to 22.5 GHz, an insertion loss variation corresponds to about 0.8±0.1 dB.

The example embodiments may minimize a phase error structurally occurring in an existing method to overcome issues of an insertion loss and a return loss. The example embodiments may also minimize an amplitude error occurring during a 0-degree or 180-degree phase shift. The example embodiments may also process a signal returned to an input port due to a mismatch in a reflective circuit. The example embodiments may also minimize a DC offset occurring in an existing method by processing the signal returned to the input port.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a to field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described example embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical to media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A phase shifter comprising:
an input unit to split an input signal into a plurality of signals having different phases;
a connection unit to change at least one of magnitudes and phases of the plurality of signals, apply the changed plurality of signals to a plurality of loads, and receive a plurality of return signals generated when the applied signals are returned by the plurality of loads; and
an output unit to generate an output signal having a predetermined phase difference from the input signal based on the return signals.

2. The phase shifter of claim 1, wherein the connection unit splits the return signals into first return signals to be applied to the input unit and second return signals to be applied to the output unit.

3. The phase shifter of claim 2, wherein the input unit outputs a leakage signal generated based on the first return signals to an isolation port.

4. The phase shifter of claim 2, wherein the output unit generates a plurality of divided output signals based on the second return signals, and generates the output signal by coupling a portion of the plurality of divided output signals.

5. The phase shifter of claim 1, wherein at least one of the plurality of loads comprises a quarter-wavelength transmission line to connect at least one of the plurality of loads to the connection unit.

6. The phase shifter of claim 1, wherein the input unit, the connection unit, and the output unit comprise identical types of couplers.

7. The phase shifter of claim 1, wherein the connection unit comprises at least two couplers.

8. The phase shifter of claim 1, wherein the plurality of loads comprises a first load and a second load, and
the first load and the second load exhibit different operation characteristics in response to an application of a control signal.

9. A phase shifter comprising:
an input coupler to split an input signal into a plurality of divided input signals;
an output coupler;
a first coupler to connect one side of the input coupler to one side of the output coupler; and
a second coupler to connect another side of the input coupler to another side of the output coupler,
wherein the first coupler and the second coupler receive the plurality of divided input signals, apply a plurality of load application signals generated based on the plurality of divided input signals to a plurality of loads, and receive return signals generated when the applied load application signals are returned by the plurality of loads, and
the output coupler outputs an output signal having a phase shifted by a predetermined value based on the return signals.

10. The phase shifter of claim 9, wherein the first coupler and the second coupler split the return signals into a plurality of divided return signals, and apply the plurality of divided return signals to the input coupler and the output coupler.

11. The phase shifter of claim 10, wherein the output coupler splits the divided return signals applied to the output coupler into a plurality of divided output signals, and generates the output signal by coupling a portion of the plurality of divided output signals.

12. The phase shifter of claim 10, wherein the input coupler outputs a leakage signal generated based on the divided return signals applied to the input coupler to an isolation port.

13. The phase shifter of claim 9, wherein at least one of the plurality of loads comprises a quarter-wavelength transmission line to connect at least one of the plurality of loads to the first coupler and the second coupler.

14. The phase shifter of claim 9, wherein the plurality of loads comprises a first load and a second load, and
wherein the first load and the second load exhibit different operation characteristics in response to an application of a control signal.

15. The phase shifter of claim 9, wherein the input coupler, the first coupler, the second coupler, and the output coupler correspond to identical types of couplers.

16. A method of shifting a phase of a signal, the method comprising:
splitting an input signal into a plurality of divided input signals having different phases;
generating a plurality of load application signals based on the plurality of divided input signals;
applying the plurality of load application signals to a plurality of loads, and receiving return signals generated when the applied load application signals are returned by the plurality of loads; and
outputting an output signal having a predetermined phase difference from the input signal based on a plurality of divided return signals generated based on the return signals.

17. The method of claim 16, wherein the outputting comprises:
splitting the plurality of divided return signals into a plurality of divided output signals; and
generating the output signal by coupling a portion of the plurality of divided output signals.

18. The method of claim 16, wherein the outputting comprises splitting the return signals into the plurality of divided return signals by applying the return signals to a coupler.

19. The method of claim 16, further comprising:
outputting a leakage signal generated based on divided return signals applied to an input coupler among the plurality of divided return signals to an isolation port.

20. The method of claim 16, wherein the generating of the plurality of load application signals comprises splitting each of the plurality of divided input signals into a plurality of load application signals by applying the plurality of divided input signals to a plurality of couplers, respectively.
